(19) United States
(12) Patent Application Publication
(10) Pub. No.: US 2023/0393881 A1
(43) Pub. Date: Dec. 7, 2023

(54) AUTONOMOUS CLUSTERS IN A VIRTUALIZATION COMPUTING ENVIRONMENT

(71) Applicant: VMware Inc., Palo Alto, CA (US)

(72) Inventors: Brian Masao Oki, San Jose, CA (US); George Gregory Hicken, San Francisco, CA (US); Mukesh Hira, Los Altos, CA (US); Leonid Livshin, Palo Alto, CA (US); Ivaylo Vladimirov Loboshki, Sofia (BG); Ivaylo Radoslavov Radev, Sofia (BG); Alkesh Shah, Palo Alto, CA (US); Jianjun Shen, Redwood City, CA (US); Abhishek Ajit Srivastava, Mountain View, CA (US); Konstantinos Roussos, Palo Alto, CA (US); Stanimir Plamenov Lukanov, Sofia (BG); Anton Valentinov Donchevski, Stara Zagora (BG); Georgi Lyubomirov Dimitrov, Plovdiv (BG)

(21) Appl. No.: 18/324,373

(22) Filed: May 26, 2023

Related U.S. Application Data
(60) Provisional application No. 63/347,815, filed on Jun. 1, 2022.

(51) Int. Cl. G06F 9/455

(52) U.S. Cl. CPC G06F 9/45558; G06F 2009/45566; G06F 2009/45591

(57) ABSTRACT

Systems, apparatus, articles of manufacture, and methods are disclosed to manage a deployment of virtual machines in a cluster by, in a first host of a plurality of hosts, monitor, with first control plane services, an availability of second control plane services at a second host of the plurality of hosts, wherein the first control plane services and the second control plane services support implementation of application programming interface (API) requests in association with managing a cluster, after a determination that the second control plane services at the second host is not available, assign the first control plane services at the first host to operate in place of the second control plane services at the second host, and in the first host, assign, via the first control plane services at the first host, resources of one or more hosts in the cluster to support the API request.

### RELATED APPLICATION

This patent claims the benefit of U.S. Provisional Patent Application No. 63/347,815, which was filed on Jun. 1, 2022. U.S. Provisional Patent Application No. 63/347,815 is hereby incorporated herein by reference in its entirety. Priority to U.S. Provisional Patent Application No. 63/347,815 is hereby claimed.

### FIELD OF THE DISCLOSURE

This disclosure relates generally to cloud computing and, more particularly, to autonomous clusters in a virtualization computing environment.

### BACKGROUND

In computing environments, clusters of computing devices can be deployed to provide redundancy and distribute resources across multiple physical devices. In some implementations, multiple host computing systems can be deployed and each host computing system can provide a physical platform for virtual machines, containers, or other virtualized endpoints. The hosts may further provide additional resources, including virtual networking, including routing, encapsulation, or other similar networking operations to support the communications of the virtual endpoints.

In some examples, an organization may deploy multiple physical clusters, wherein each of the clusters may include a plurality of hosts. The clusters may be deployed in a single datacenter or can be deployed across multiple datacenters, edge deployments (stores, workplaces, and the like), and geographic locations. To support the deployment of virtual endpoints, including virtual machines, a centralized control service can be used to monitor resource usage at the various clusters, distribute and configure the virtual machines in the various clusters, or provide some other similar operation. However, while a central control service can be used to deploy virtual machines across different clusters, difficulties can arise when the central control service is unable to communicate with one or more of the available clusters, a client is unable to communicate with the central control service, or the control service becomes unavailable. This can prevent virtual machines from being deployed, migrated, stopped, or other similar operations with the endpoints at the various clusters.

### SUMMARY

The technology described herein manages autonomous clusters in a computing environment. In one implementation, a method of operating a first host in a cluster of hosts includes monitoring availability of control plane services at a second host in the cluster, wherein the control plane services support implementation of API requests in association with managing the cluster. In response to determining that the control plane services at the second host are not available, the method further includes assigning control plane services at the first host to act in place of the control plane service as the second host. The method also includes, in the first host, identifying an application programming interface (API) request in association with at least one virtual machine for the cluster and assigning host resources of one or more hosts to support the API request.

### BRIEF DESCRIPTION OF THE DRAWINGS

FIG. 1 illustrates a cluster to provide high availability for a control plane according to an implementation.

FIG. 2 illustrates a flowchart representative of example machine readable instructions and/or example operations that may be executed, instantiated, and/or performed by example programmable circuitry to operate a cluster to provide control plane operations according to an implementation.

FIG. 3 illustrates a timing diagram for deploying a virtual machine in a cluster according to an implementation.

FIG. 4 illustrates an operational scenario of a failover of a virtual IP address from a first host to a second host according to an implementation.

FIG. 5 illustrates an operational scenario for failover of a leader control plane service from a first host to a second host according to an implementation.

FIG. 6 illustrates an operational scenario for a failover of a control plane service in a cluster according to an implementation.

FIG. 7 is a block diagram of an example implementation of a host computing system to provide control plane services according to an implementation.

FIG. 8 is a flowchart representative of example machine readable instructions and/or example operations that may be executed, instantiated, and/or performed by example programmable circuitry to implement the host computing system of FIG. 7 to control hosts.

FIG. 9 is a block diagram of an example processing platform including programmable circuitry structured to execute, instantiate, and/or perform the example machine readable instructions and/or perform the example operations of FIGS. 2 and/or 8 to implement the host computing system 700 of FIG. 7.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 2 and/or 8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

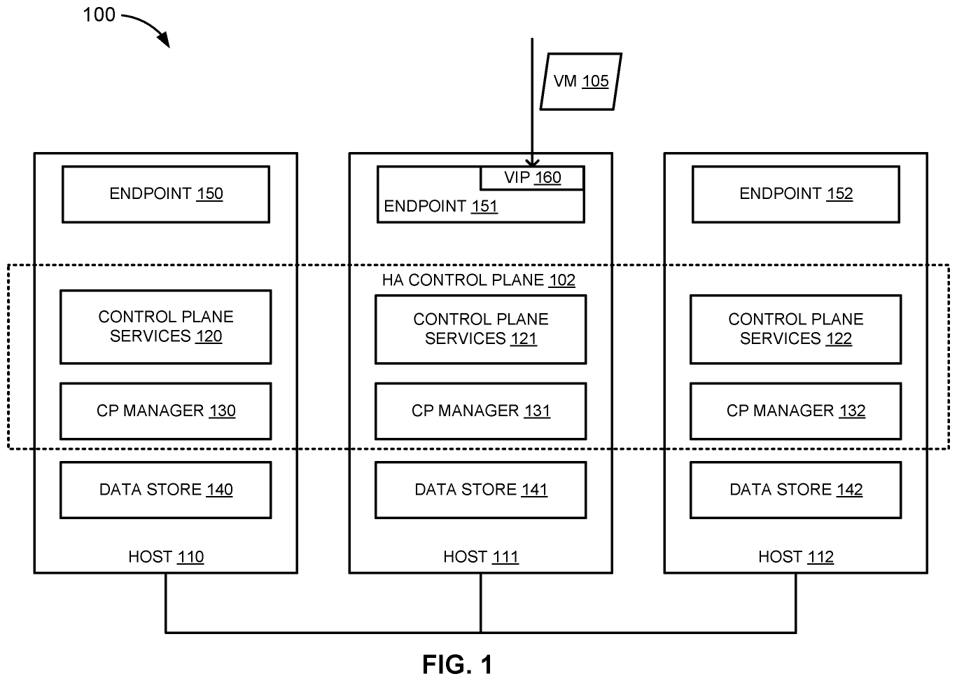

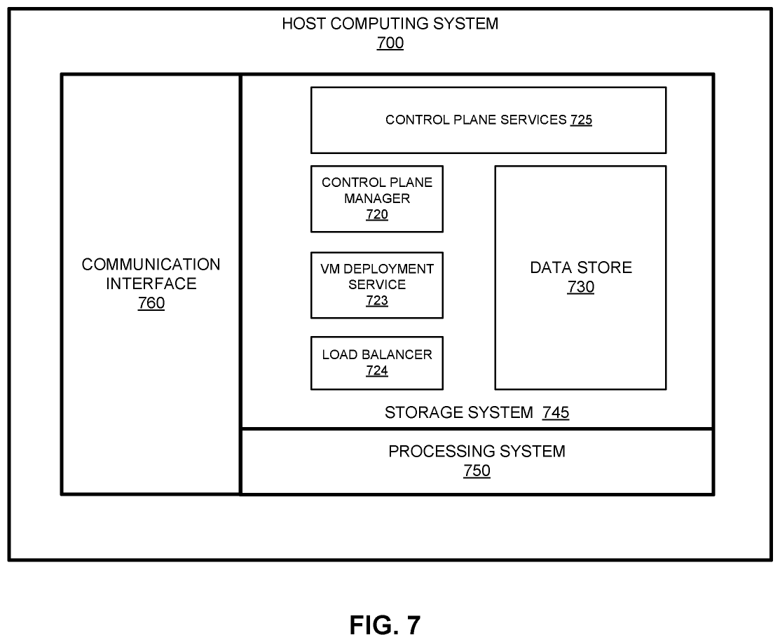

FIG. 1 describes an example cluster 100. The example cluster 100 includes an example first host 110, an example second host 111, and an example third host 112. However, in other examples, more or fewer hosts may be present in the example cluster 100. The example hosts 110-112 include circuitry, which is described below in connection with FIG. 7. Turning briefly to FIG. 7, FIG. 7 describes an example host computing system 700. The example host computing system 700 (FIG. 7) may be implemented as the example first host 110, the example second host 111, and/or the example third host 112.

The example host computing system 700 includes an example control plane manager 720, example virtual machine deployment services 723, the example load balancer 724, example control plane services 725, an example processing system 750, and an example communication interface 760. In examples disclosed herein, when describing a component that belongs to a specific host, the reference numeral referred to in such description corresponds to the specific host. However, when describing the component in general, the reference numeral referenced in such description corresponds to FIG. 7. For example, the example control plane services 725 of FIG. 7 is implemented in the example first host 110 as control plane services 120. Similarly, the example control plane services 725 of FIG. 7 is implemented in the example second host 111 as control plane services 121. Finally, the example control plane services 725 of FIG. 7 is implemented in the example third host 112 as control plane services 122. The example control plane manager 720 of FIG. 7 is implemented in the example first host 110 as example control plane (CP) manager 130.

Returning to FIG. 1, the example cluster 100 is structured to provide high availability for a control plane according to an implementation. Example cluster 100 includes hosts 110-112, wherein hosts 110-112 further include endpoints 150-152, control plane services 120-122, control plane managers 130-132, and data stores 140-142. Example control plane services 120-122 and control plane managers 130-132 operate as part of a high availability (HA) control plane 102. The example second host 111 further includes virtual IP address 160 that is used to receive commands, including application programming interface (API) commands in association with the deployment of one or more virtual machines, such as virtual machine 105. Example hosts 110-112 represent physical computers, which can each include memory and at least one processing system to provide the operations disclosed herein. While demonstrated in the example of cluster 100 using three hosts, a cluster may include any number of hosts. For example, one or more additional hosts may include resources for executing virtual endpoints including storage resources, processing resources, or some other resource to support one or more virtual endpoints.

Example cluster 100 is an example cluster that can be deployed by an organization to provide resources for virtual endpoints, including virtual machines, containers, and the like. Example hosts 110-112 can abstract the physical components and provide the physical components to the virtual machines or other virtualized endpoints, wherein the resources can include processing resources, memory resources, networking resources, and the like. The organization may deploy one or more clusters within the same datacenter or across multiple datacenters in different geographic locations. These locations can be remote or moveable, such as retail locations, cruise ships, oil rigs, or other similar deployments of hosts for virtual machines. When a virtual machine is to be deployed (e.g., virtual machine 105), a request associated with the virtual machine is communicated to a host in example cluster 100. Here, the request for virtual machine 105 is received at virtual IP address 160 associated with the example second host 111. Virtual IP address 160 is representative of an IP address that can be used by a client to communicate the request for the virtual machine to the cluster, wherein the request may include hardware requirements or service level requirements associated with the virtual machine, software requirements associated with the virtual machine, networking requirements, or some other requirements associated with the virtual machine. The virtual IP address can be available to multiple hosts, but a single host may assume responsibility for packets destined to the virtual IP address. Thus, in the example of FIG. 1, while the virtual IP address is assumed by the second host 111, the same virtual IP address can be reassigned to another host in cluster 100 during a failure of the second host 111.

Although demonstrated as being received at the second host 111, in some examples any host within cluster 100 can be capable of receiving the request for the virtual machine. For example, a client service may identify an IP address associated with the first host 110 and communicate the request to unique IP address associated endpoint 150 rather than the virtual IP address 160. Although demonstrated as requests being originated from outside the cluster 100, clients within the cluster 100 can be used to originate API requests associated with the cluster 100. The requests can be used to initiate virtual machines, conserve, or manage resources with a host, or provide some other operation. As an example, a virtual machine executing in the cluster 100 may generate a request that is received at the endpoint or virtual IP address, the request can then be forwarded to an instance of the control plane services to implement the request.

In response to receiving the request for virtual machine 105, the example second host 111 may perform load balancing to select a host from hosts 110-112 to provide the control plane services for the request. The control plane services may be used to monitor resource availability in the cluster 100, identify resource requirements for the virtual machine, store configuration information associated with virtual machines in a data store of data stores 140-142, or provide some other operation. The example control plane services 120-122 may each represent one or more containers or other virtualized endpoints managed by control plane manager 130-132. The one or more containers can be assigned an overlay IP address, wherein traffic between the hosts is encapsulated as part of an underlay network between the hosts. The control plane manager 130-132 may manage the images and resources that are provided to each of the control plane services.

In some implementations, the control plane services 120-122 are implemented as a leader with one or more followers. For example, control plane services 120 can represent a leader, while control plane services 121-122 represent follower services. Example control plane services 120 may perform signature checks on the request for the virtual machine (e.g., source of the virtual machine) and store configuration information associated with the virtual machine in data store 140, wherein configuration information may include resource requirements, software requirements, and the like. Example control plane services 121-122 may also perform checks on the request for virtual machine 105 to determine whether a quorum is met and approves the initiation of the virtual machine. If a quorum is not met, or two out of the three control plane services do not verify the request for the virtual machine, then the virtual machine will not be initiated in example cluster 100. In contrast, when a quorum is established for virtual machine 105, the example control plane services 120 may permit the virtual machine to be initialized. The quorum can be established using an exchange of signature information in an overlay network between control plane services 120-122. Example control plane services 120 may identify resource availability information derived from each host of hosts 110-112, the resource requirements of the virtual machine, or some other factor. Once a host is selected to support the virtual machine, control plane services 120 initiates the virtual machine on the corresponding host. The initiation may include communicating with an agent or service on the corresponding host to initiate the virtual machine, wherein the virtual machine may use the data stored across data stores 140-142.

Although demonstrated in the previous example using a single leader for the control plane services, alternative configurations are possible in association with the control plane services. In at least one example, control plane services 120-122 may each include a leader in HA control plane 102. Advantageously, rather than relying on a single leader to initiate a virtual machine, each of the control plane services may receive a request and process the request when a quorum is reached in association with the request. As an example, when a request is received using virtual IP address 160 for virtual machine 105, a load balancer (e.g., load balancer 724 of FIG. 7) on the second host 111 can select any of control plane services 120-122 to support the request. The load balancer may use random selection, resource-based selection, or some other selection process to distribute the request to the control plane services. Once received, the control plane service may verify the request using signature information or encryption in association with the request and may further communicate with other control plane services in HA control plane 102 to determine whether a quorum exists for the request. When a quorum exists, then the selected control plane services may initiate an operation to deploy the virtual machine. Otherwise, when a quorum does not exist, the selected control plane services may prevent the initiation of the virtual machine.

In another example, rather than using a quorum to approve a new virtual machine, a single instance of control plane services may execute on a host of the cluster. For example, control plane services 120 may execute on the first host 110, while hosts 111-112 may include standby resources that can initiate execution of local control plane services 121 or 122 in response to detecting a failure of control plane services 120 at the first host 110. When a request is received at one of hosts 110-112, the request is forwarded to control plane services 120, wherein example control plane services 120 may verify the request and initiate deployment of the virtual machine.

In some implementations, example control plane manager 130-132 can be used to initiate corresponding control plane services 120-122 and maintain state information associated with the control plane services. The state information may include the location of different virtual machines within the cluster, a list of the virtual machines deployed, or some other stateful information associated with the virtual machines. The information can be distributed and shared in HA control plane 102.

In some examples, data stores 140-142 may represent a high availability data store that can store multiple copies of the configuration data across multiple hosts. Although demonstrated as on the same host as the control plane services, the data store may exist on hosts separate from the control plane services. Like the high availability control plane services 120-122, each data store may maintain its own copy of the corresponding configuration data. The configuration data may include cluster configuration data, including hosts that are in the cluster, cluster networking configurations, resource pools and the like, may include cluster personality information, such as the host images and configurations, and may further include the virtual machine specific configurations (software, hardware requirements, and the like). Each data store may include the requisite information to recover the cluster without assistance from outside computing resources, wherein the recovery can include failures associated with software, power outages, or some other failure. Advantageously, with the combination of the control plane services and the data store, the cluster can be autonomous, permitting API actions to be implemented and processed locally, and permitting recovery from failures using the configuration data maintained in the high availability data store.

In maintaining the high availability of the data stores, each data store of example data stores 140-142 may store a copy of the configuration data. The data stores may perform leader-follower quorums for the various writes to the data store to ensure that each of the data stores includes the same data. For example, data store 140 may represent a leader in the high availability data store. When a request is received from an instance of control plane services, such as example control plane services 120, to write data to data store 140, data store 140 may determine whether a quorum can be reached for the write with the other data stores. When a quorum is reached, the write can be executed, wherein the write may comprise a key-value store to maintain the organization of the configuration data across the data stores.

Additionally, in some examples, quorums may also be required when reading from the data store to ensure that the data matches across the different data stores. For example, when an instance of control plane services 120-122 requires a read from the high availability data store, the control plane services may be directed to the leader of the data stores to ensure that the most recent data is available for the read. Specifically, while a quorum is used to verify the write of the data, the leader of data stores 140-142 may have the most recent data, while other data stores can take time on writing and updating the same data.

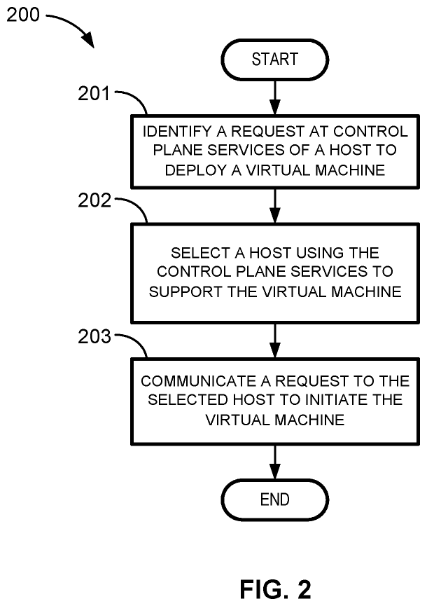

FIG. 2 illustrates a flowchart representative of example machine readable instructions and/or example operations that may be executed, instantiated, and/or performed by example programmable circuitry to operate a cluster to provide control plane operations according to an implementation. Blocks of example instructions 200 are referenced parenthetically and are described with reference to systems and elements of cluster 100 of FIG. 1.

Example instructions 200 include identifying (block 201) a request to deploy a virtual machine at control plane services at a host of a cluster. In some examples, the request for the virtual machine is communicated to a virtual IP address, wherein a host within the cluster is responsible for processing the requests to the virtual IP address. For example, in cluster 100, endpoint 151 may be responsible for receiving a request to virtual IP address 160. In other examples, the requests may be directed at an individual public IP address associated with one of endpoints 150-152. In response to receiving the request, a load balancer (e.g., the load balancer 724 of FIG. 7) located on the receiving host may identify control plane services of control plane services 120-122 to support the request and forward the request to the corresponding control plane services. The selection of the control plane services may include the control plane services that are active, wherein the remaining hosts provide standby support in event of failure of the active control plane services, the selection may include a leader in the cluster when the cluster provides a leader-follower configuration or may include a selection of a leader from a set of leaders when multiple leader control plane services are available. As an example, when a packet is received at endpoint 151, the load balancer at the second host 111 may select control plane services for the request and forward the request to the control plane services 121 at the second host 111. In some implementations, the forwarding may use an overlay network, which represents a private network associated with requests in the HA control plane 102.

Once the control plane services 121 receives the request, the example instructions 200 further include selecting (block 202) a host using the control plane services 121 to support the virtual machine deployment. The selection can be based on the requirements, physical and software requirements for the virtual machine, the available resources at the various hosts, or some other factor. In at least one implementation, prior to initiating the virtual machine or selecting the host to support the virtual machine, the control plane services 121 may establish a quorum for the request, wherein the quorum can be used to verify that the request for the virtual machine is valid. This may include each of the control plane services 120-122 of the hosts 110-112 verifying the request prior to implementation and requiring a quorum of the control services approving the request. The verification process may include verifying the signature of the request using encryption keys or some other mechanism to identify the source of the request. The quorum operations can be used in configurations with a leader and one or more followers or multiple leaders. Once a quorum is established for the request, the leader control service to which the request was allocated by the load balancer can select a host of the hosts 110-112 to support the virtual machine deployment.

After selecting the virtual machine, the example instructions 200 also provide for communicating (block 203) a request to the selected host to initiate the virtual machine. The communication may identify requirements associated with the virtual machine, a location of data associated with the virtual machine, or any other information permitting the selected host to initiate the virtual machine. In some examples, the data for the virtual machine can be local to the selected host. However, the data may be located on a separate host in the cluster. As an example, example control plane services 120 may represent the single leader in HA control plane 102. In response to verifying the request for virtual machine 105 via a quorum with control plane services 121-122, example control plane services 120 may select the third host 112 to support the virtual machine 105. Additionally, example control plane services 120 may store configuration information for the virtual machine in data store 140 (or can distribute the data across data stores 141-142), wherein the configuration information may indicate software requirements, hardware requirements, or some other information in association with the initiated virtual machine. The example control plane manager 130 can support the runtime of control plane services 120 and can be used to initiate control plane services 120 and communicate with other hosts 111-112 capable of supporting the control plane services 121, 122. The example control plane manager 130 can also maintain images associated with control plane services 120.

Although demonstrated in the previous example using a request to initiate a new virtual machine, other API requests can be received and processed by the cluster. The API requests may be used to configure a cluster (e.g., initiate or terminate a virtual machine), creating snapshots or clones of virtual machines, perform resource management policies, perform storage management, perform host power-saving management, or perform some other action. In at least one example, the leader or active instance of the control plane services identifies an API request in association with at least one virtual machine for the cluster and assigns resources of one or more hosts in the cluster to support the request. For example, if the API request comprised a request to generate snapshots associated with virtual machines, then the control plane services can identify one or more hosts associated with the virtual machines and allocate resources to implement the desired snapshots on one or more hosts of the cluster.

In some examples, HA control plane 102 will become active when a remote controller is unavailable to support the implementation of the API requests. The remote controller can be used to implement API requests across multiple clusters and manage the deployment of virtual machines and other virtualized endpoints in the various clusters. The remote controller can include one or more physical computers that support the management across the clusters. In at least one example, the client and/or the cluster may determine when a failure occurs with the remote controller. The failure can be identified using heartbeat messages or other status communications with the remote controller. Failures can include hardware or software failures with the controller, network connectivity between the client initiating the request and the remote controller, network connectivity between the remote controller and the cluster, or some other failure. When a failure is identified, example control plane manager 130-132 can initiate control plane services 120-122 to provide the operations described herein. The failure can be identified locally via a failed communication with the remote controller or can be identified via a notification from a requesting client.

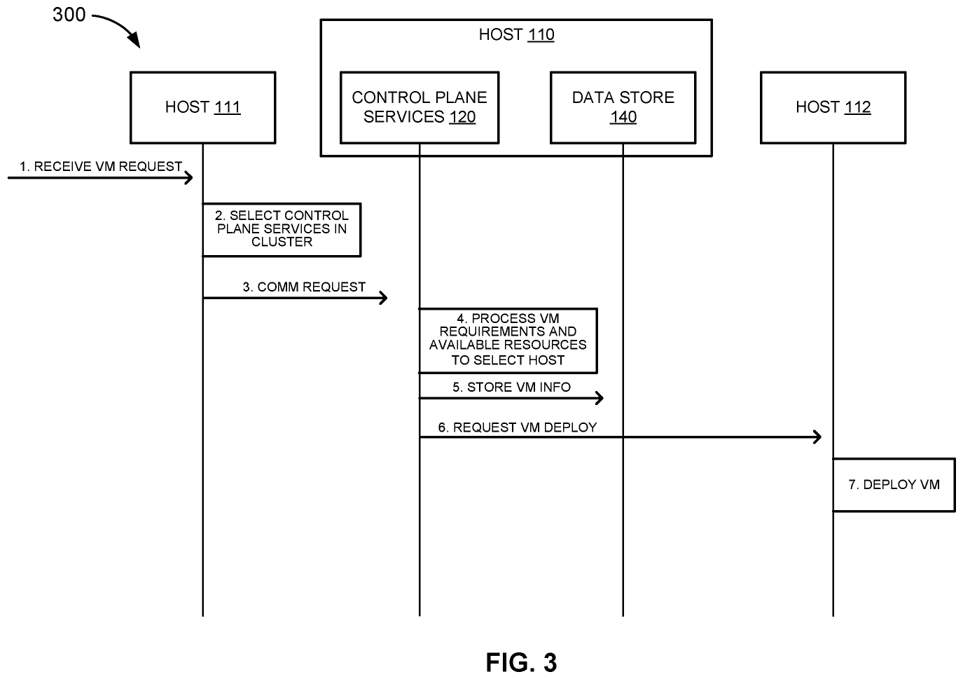

FIG. 3 illustrates a timing diagram 300 for deploying a virtual machine in a cluster according to an implementation. Example timing diagram 300 includes hosts 110-112 of cluster 100 from FIG. 1, and further includes control plane services 120 and data store 140 from the first host 110.

In timing diagram 300, the example second host 111 receives a virtual machine request at step 1 to initiate a virtual machine in the cluster 100. In some examples, the request may include an API request from a client system to deploy a new virtual machine in the cluster 100. The request can be received at a virtual IP address assigned to the hosts 110-112 of the cluster 100 or can be received at a dedicated IP address for the second host 111. In response to receiving the request, the second host 111 can use load balancer to select, at step 2, control plane services at a host in the cluster 100 (e.g., such as the control plane services 120 at the first host 110). In some implementations, the control plane service circuitry can operate on a single host (e.g., the first host 110) with one or more other hosts (e.g., the second host 111 and the third host 112) providing failover for the single host (e.g., the first host 110). In other implementations, a host can be selected based on a leader-follower quorum relationship, wherein the load balancer can select control plane services that are in a leader role. In at least one example, the control plane services may advertise to the load balancer indicating the control plane services that should be used to support the request.

After a host is identified, the example second host 111 communicates the request to control plane services 120 of the first host 110 at step 3. In some examples, the communication of the request may be accomplished using an overlay network, wherein the overlay network can include a private network for communication between multiple instances of control plane service circuitry and multiple instances of load balancer. After receiving the request, the example control plane services 120 of the first host 110 processes the virtual machine requirements and available resources to select a host for the virtual machine. The required resources for the virtual machines may include processing resources, memory resources, networking resources, or some other resources. The available resources for the various hosts can be provided by the at various intervals, permitting example control plane services 120 to select the host to support the new virtual machine. In some implementations, prior to initiating the virtual machine, control plane services 120 may communicate with the control plane services on one or more other hosts to determine whether a quorum exists that approves the request for the virtual machine. In some examples, each of the instances of control plane service circuitry can check the signature of the request to determine whether the request originates from an approved source. If a quorum exists, then the control plane services 120 of the second host 111 can initiate the selection of the host for the virtual machine. However, if a quorum cannot be established for the request, then a host will not be selected by the control plane services 120 of the first host 110.

In another implementation, the example control plane services 120 represents active control plane service circuitry, wherein one or more hosts can provide standby control plane service circuitry upon determination that one of the instances of control plane services are inactive. Accordingly, in this configuration, control plane services 120 may identify a host without requiring a quorum from instances of control plane services on other hosts.

In addition to processing the virtual machine requirements and the available resources of the hosts to select a destination host for deploying the virtual machine, example control plane services 120 of the first host 110 further stores virtual machine information in data store 140 at step 5. The virtual machine information may include configuration information associated with the virtual machine, such as resource requirements, image requirements, application requirements and the like, a location or host for deploying the virtual machine, or some other information associated with the virtual machine. The information for the virtual machine can be stored after or prior to identifying a host to support the execution of the virtual machine.

Once the host is selected for the virtual machine, example control plane services 120 generates a request to the example third host 112 to deploy the virtual machine at step 6. In some examples, the request is communicated to a daemon service operating on the example third host 112 that can allocate the required resources and initiate the virtual machine, while pointing the virtual machine to the requested disks and storage resources (e.g., virtual disks). The storage resources can be local to the third host 112 or can be distributed on one or more hosts in the cluster. After receiving the request, the daemon service can deploy the virtual machine at step 7.

Although demonstrated in the example of FIG. 3 with a request to initiate a virtual machine, other API requests can be processed using the control plane services, wherein the API requests include requests in association with managing the cluster. The requests can be used to create snapshots or clones of one or more virtual machines, perform resource management allocated to the virtual machines, perform storage management, perform host power saving, or some other management operation. When a request is received by the control plane services in association with at least one virtual machine (including the host of a virtual machine, storage available to the virtual machine, and the like), the control plane services may assign resources of one or more hosts in the cluster 100 to support the request. For example, an API request to generate a snapshot of a virtual machine may trigger the control plane services to initiate a snapshot operation on the host with the virtual machine and reserve storage resources to store the snapshot. Advantageously, rather than relying on external systems, the cluster 100 can be autonomous, permitting the instances of the example control plane services to implement desired operations in association with API requests, store data associated with the configuration of the cluster in a data store, and recover or update a cluster 100 in response to a failure using the stored configuration data for the cluster 100.

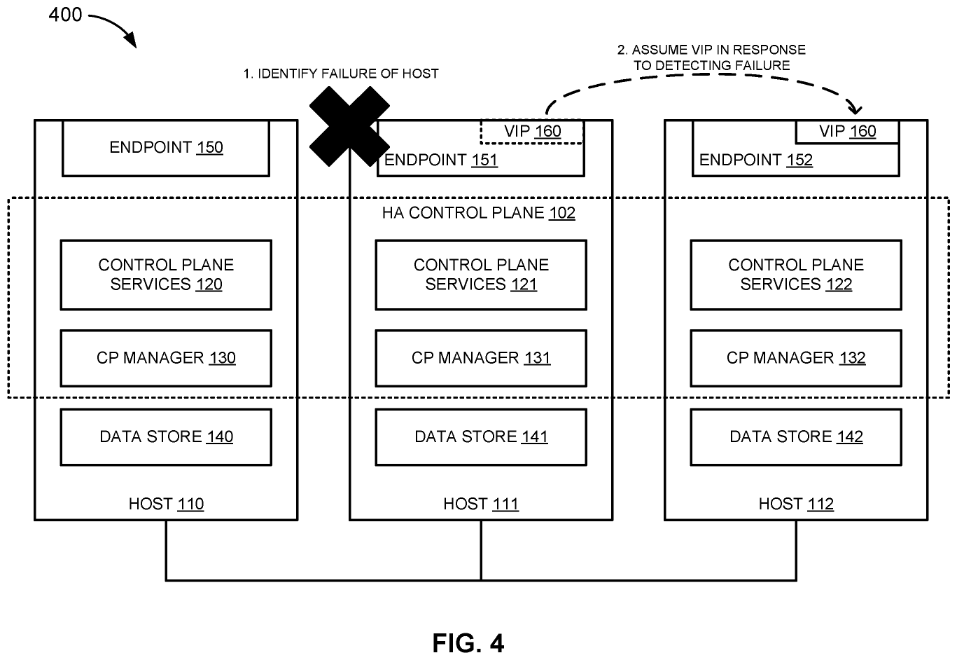

FIG. 4 illustrates an operational scenario 400 of a failover of a virtual IP address from a first host (e.g., the second host 111) to a second host (e.g., the third host 112) according to an implementation. Operational scenario 400 includes systems and elements from the example cluster 100 of FIG. 1. Although demonstrated as a failure of an entire host, other failures can include hardware and/or service failures associated with a host.

In a cluster, a virtual IP address can be used that permits a client to communicate with the cluster using a single address, wherein a host of the cluster can be assigned to receive packets with the destination virtual IP address. Here, the second host 111 is initially assigned virtual IP address 160, wherein virtual IP address 160 can be used by a client or other system to provide requests in association with virtual machine deployments in the cluster. Prior to a failure, requests can be received using the virtual IP address, and assigned to control plane services of control plane services 120-122 using a load balancer (e.g., the load balancer 724 of FIG. 7) at the second host 111. The example load balancer can select the instance of control plane services to support the request based on which instance of the control plane services is assigned as a leader in the cluster or based on which one of the instances of the control plane services are currently in an active role. As an example, the control plane services 120 of the first host 110 can be assigned to be the leader of a cluster. The example control plane services 120 can report the leadership role of the example control plane services 120 to the load balancer, can be reported by another service in HA control plane 102 to the load balancer, or can be reported in some other manner. Once forwarded to the leader or current active instance of control plane services, the control plane services may select a host to support the virtual machine based on the requirements for the virtual machine, and the available resources of hosts 110-112. The leader or active control plane service may also store configuration information associated with the virtual machine in the data store (e.g., the first data store 140, the second data store 141 or the third data store 142 of FIG. 1). The data store can be local to the host with the control plane services or can be in another host.

In example FIG. 4, the second host 111 encounters a failure at step 1, wherein the failure can be identified using heartbeat messages for the instances of control plane services associated with HA control plane 102. For example, control plane services 122 of the third host 112 and control plane manager 132 of the example third host 112 may monitor and identify a failure associated with the second host 111 when a response message is not received from the second host 111. In response to identifying the failure, the third host 112 can assume the virtual IP address 160, permitting the third host 112 to act in place of the second host 111. The selection of the third host 112 to act in place of the second host 111 can be selected randomly, can be selected based on the available resources of the hosts, or can be selected in some other manner using the first host 110 and/or the third host 112. Once selected, the third host 112 may receive and process packets addressed to a private virtual IP address 160 in place of the second host 111. Further, if example control plane services 121 provided follower support for a quorum in HA control plane 102, the quorum can still be supported using control plane services 120 of the first host 110 and control plane services 122 of the third host 112, wherein a quorum would require both services to approve a virtual machine operation prior to implementation.

In some implementations, the control plane services 120-122 each can provide different services in association with the virtual machine requests. For example, while the control plane services 120 of the first host 110 may act as the leader in the cluster of control plane services, the other control plane services may only execute operations to perform the quorum or signature checks in association with the requirements. At least one other instance may replace the services provided by control plane services 120 (e.g., services to select a host to support a request for a virtual machine) only after a failure associated with control plane services 120 of the first host 110.

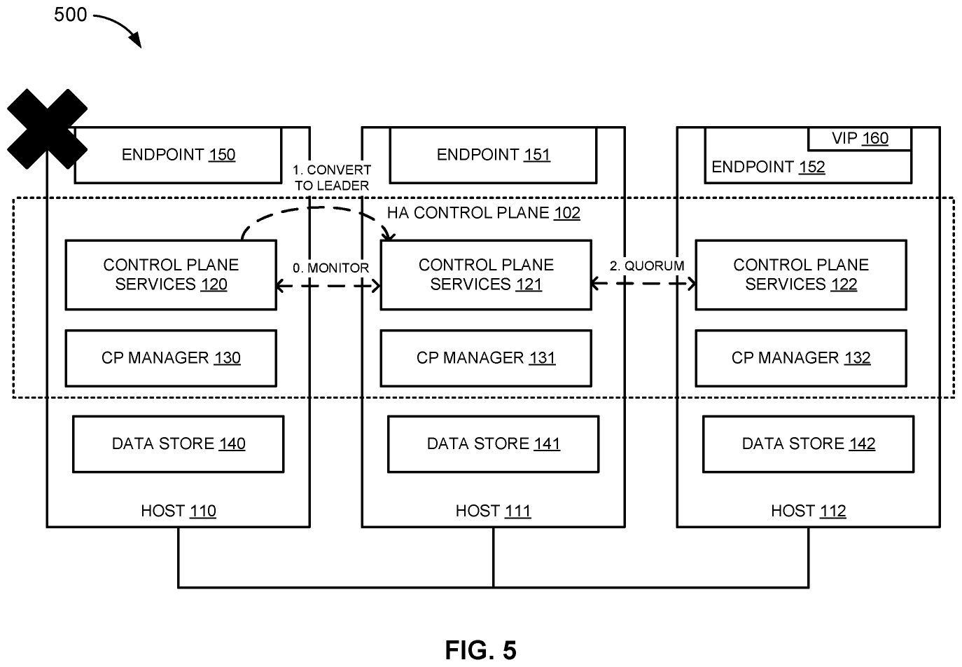

FIG. 5 illustrates an operational scenario 500 for failover of a leader control plane service from a first host (e.g., the first host 110) to a second host (e.g., the second host 111) according to an implementation. Operational scenario 500 includes systems and elements from cluster 100 of FIG. 1.

In operational scenario 500, example control plane services in the example HA control plane 102 communicate messages to identify and monitor availability of the example control plane services 120-122 at step 0. The monitoring may include heartbeat messages that can be communicated at various intervals to determine when an instance of the control plane services becomes unavailable. Here, the control plane services 120 of the first host 110 is initially in the leader role in the HA control plane 102. The leader can be responsible for implementing the desired virtual machine action, including selecting a host for a virtual machine and deploying the virtual machine, removing a virtual machine, or providing some other operation. The example control plane services 121-122 provide a follower role in the HA control plane 102, which are used to provide a quorum in association with the virtual machine requests. Accordingly, while the example control plane services 120 of the first host 110 may implement the requests, the example control plane services 121-122 of the second host 111 and the third host 112 may be used to verify the signature associated with the request.

In example FIG. 5, while monitoring the availability of the control plane services 120 of the first host 110, a failure is identified in association with the example control plane services 120. The failure may include a hardware failure, a software failure, or some other failure. For example, the first host 110 may experience a power failure or initiate an update that is identified by at least one other instance of the control plane services. In response to identifying the failure, a second instance of control plane services is identified to replace control plane services 120. In some examples, a default failover can be selected, wherein the control plane services 121 of the second host 111 can act in place of control plane services 120 of the first host 110 when the failure is identified. In other examples, the selection can be made using the remaining available instances of control plane services and control plane manager instances. Thus, a selection is made between control plane services 121-122 as to which of the instances of control plane services will be converted to replace the example control plane services 120.

In the present example, control plane services 121 of the second host 111 is selected and operational scenario 500 converts, at step 1, the example control plane services 121 to act in place of the example control plane services 120 of the first host 110. In converting or replacing the unavailable control plane services, the example control plane services 121 may advertise itself as the leader of the cluster, including notifying load balancers on any of the available hosts 110-112, may execute one or more services to select hosts for virtual machines, or may provide some other operation to act in place of control plane services 120. When a request is received in association with a new virtual machine, the request is forwarded to the example control plane services 121. The example control plane services 121 may determine whether a quorum exists that permits the initiation of the virtual machine at step 2, and once permitted, select an available host to support the virtual machine. The selection can be based on the resource requirements of the virtual machine, the available resources of the hosts, or some other factor. Once selected, the control plane services 121 may communicate with a service on the designated host to provide the desired operation (e.g., initiate a virtual machine).

While demonstrated in the above example as converting a follower service to a leader service, similar operations may be used to convert the control plane services 121 of the second host 111 to an active state from a standby state in response to the failure of control plane services 120 of the first host 110. Additionally, in the example where the example control plane services 120-122 each includes a leader, no changes may be made in the state of the remaining control plane services 121-122. Rather, the control plane services 121 of the second host 111 may rely on the control plane services 122 of the third host for the quorum determination without the use of control plane services 120 of the first host 110. Similarly, the control plane services 122 of the third host 112 may rely on the control plane services 121 of the second host 111 for the quorum determination without the use of control plane services 120 of the first host 110.

Although demonstrated in the examples of operational scenarios of FIGS. 1-5 as initiating a virtual machine, other requests can be received and processed using the control plane services 120-122. The requests may include requests to remove virtual machines, duplicate a virtual machine, or provide some other operation with the virtual machines. In some implementations, the requests can include API requests from client systems or other systems with instructions associated with the desired operation. The API requests can be processed by the example control plane services 120-122 to implement the desired operation. The various API requests can be used to initiate a new virtual machine or virtual machines, create snapshots or clones of one or more virtual machines, perform resource management allocated to the virtual machines, perform storage management, or perform host power saving.

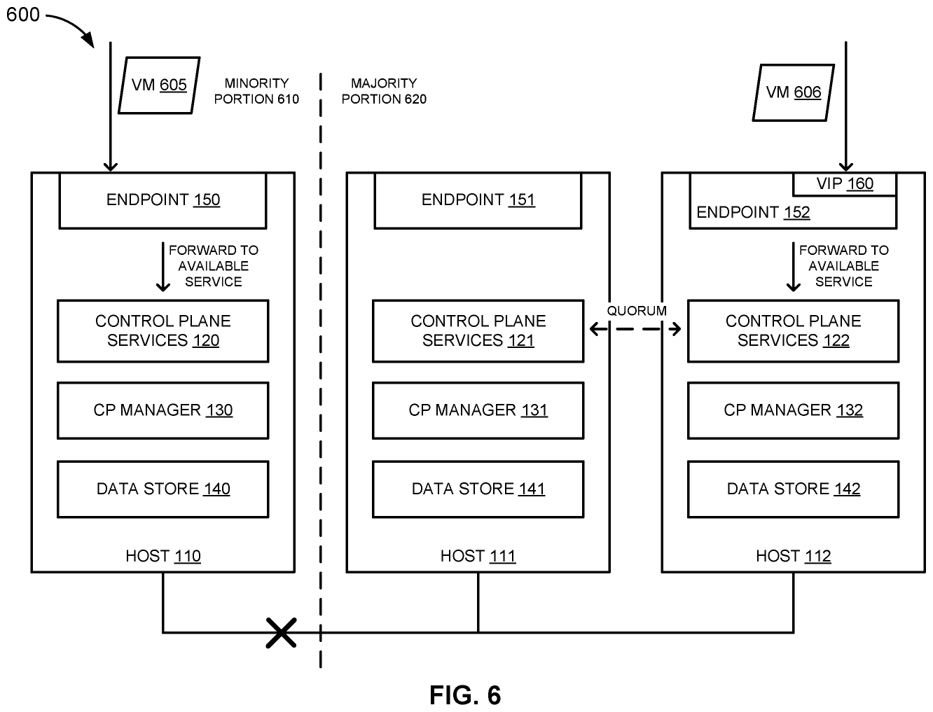

FIG. 6 illustrates an operational scenario 600 for a failover of an instance of control plane services 725 in a cluster according to an implementation. Operational scenario 600 includes systems and elements from cluster 100 of FIG. 1. Operational scenario 600 further includes minority portion 610 and majority portion 620, where the portions receive requests for virtual machines 605-606. Operational scenario 600 uses a quorum mechanism for implementing a virtual machine request, wherein multiple instances of control plane services across multiple servers are used to verify a request prior to implementing the request.

In operational scenario 600, network segmentation divides cluster 100 into a minority portion 610 and a majority portion 620. The segmentation may occur because of a failure in a networking element, a failed networking configuration that prevents communication between the hosts of the cluster, or for some other reason. After the failure, demonstrated with the first host 110 in minority portion 610 and the second host 111 and the third host 112 in majority portion 620, a first request for virtual machine 605 is received at endpoint 150. Here, because the example control plane services 121-122 are unavailable, the request is forwarded to control plane services 120. In some implementations, the load balancer (e.g., the load balancer 724 of FIG. 7) of the first host 110 may identify the failure or the inability to communicate with the other control plane services and may select an available services instance. In other implementations, the load balancer (e.g., the load balancer 724 of FIG. 7) may receive an indication of the available instances of the control plane services (e.g., the control plane services 725 of FIG. 7). Once forwarded, control plane services 120 of the first host 110 may determine a host to support the virtual machine request and may generate a request to initiate the requested virtual machine on the selected host.

Here, in the example of virtual machine 605, the control plane services 120 may determine that the other instances of control plane services (e.g., the control plane services 121, 122) are unavailable, limiting the ability of control plane services 120 to determine whether a quorum exists for the request. In this example, control plane services 120 may select a host for the virtual machine and initiate the process of deploying the virtual machine. Additionally, the control plane services 120 of the first host 110 may cache, using a log, configuration information associated with the virtual machine. Once a connection is reestablished with the other instances of the control plane services (e.g., the control plane services 121 of the second host 111 and the control plane services 122 of the third host 112 of the majority portion 620), the instances of the control plane services may determine whether the request was valid. If valid, the deployment of the virtual machine is permitted, and the cached configuration information may be stored in the data store (e.g., in the example data store 140 of the first host 110, in the example data store 141 of the second host 111, or in the example data store 142 of the third host 112). In contrast, if the deployment of the virtual machine is not permitted, then the virtual machine can be stopped, and any information stored in the log removed.

In other implementations, rather than optimistically initiating a virtual machine when no quorum is available, the example control plane services 120 of the first host 110 may stop the deployment of a virtual machine. For example, when the request for the virtual machine 605 is received, the example control plane services 120 may determine that no quorum can be reached for the example virtual machine 605 and block the deployment of the example virtual machine 605. Additionally, the first host 110 may cache the request information, such that the example virtual machine 605 can be deployed once the connection between the hosts 110-112 is reestablished.

Turning to the request for virtual machine 606 that is received at virtual IP address 160 supported by the third host 112, a load balancer (e.g., the load balancer 724 of FIG. 7) on the third host 112 can select an instance of control plane services 121-122 to support the request. Here, the first host 110 is unavailable due to a connectivity issue between the hosts. Accordingly, the control plane services 121-122 can provide a quorum without the use of control plane services 120. When the load balancer selects control plane services 122, the control plane services 122 of the third host 112 may determine whether a quorum exists with the control plane services 121 of the second host 111 and select a host to support the operation. The example control plane services 122 may represent a single leader in a leader-follower configuration for a cluster or may represent an example leader, wherein the load balancer (e.g., the load balancer 724 of FIG. 7) can select any control plane services instances that support Advantageously, so long as at least two instances of the control plane services (e.g., the control plane services 725 of FIG. 7) are available, then a quorum can be established for a request and the request initiated.

In some examples, data stores 140-142 provide a high availability data store, where each of the data stores can store a replica of the configuration data for the cluster. The configuration data can be used to recover the cluster after a hardware or software failure in the cluster. Although demonstrated in the examples of cluster 100 of FIG. 1 as being stored on the same host as the control plane services (e.g., the control plane services 725 of FIG. 7), the data store may be on a separate host in some examples. For example, a fourth host (not pictured) may include a data store that includes an instance of the data store (e.g., the data store 730 of FIG. 7). The data stores may use quorums to determine when to write new data to each of the data stores, where the data may be written in the form of a key-value pair to maintain consistency between the data stores. Additionally, in some examples, quorums may also be required when reading from the data store to ensure that the data matches across the different data stores.

During a failure, one or more of the data stores may become unavailable. Depending on the requirements of the cluster, an API request can be satisfied or prevented from being implemented. For example, when data consistency is required, an API request may be blocked if the high availability data store does not have a quorum to store the data. In other examples, a configuration can permit eventual consistency by writing to a log indicating the modification in the data store and waiting until a quorum can be reached. The log can be used if the data store and/or the instance of the control plane services are in the minority. An example of this is the request for virtual machine 605, where the control plane manager 130 of the first host 110 and the example data store 140 of the first host 110 are in the minority portion 610 but can initiate the required operation by writing to a log that can be checked when the connectivity issue is resolved with the other instances of control plane services (e.g., the control plane services 725 of FIG. 7) and instances of data store (e.g., the data store 730 of FIG. 7).

Although demonstrated in the example of cluster 100 as including three hosts, any number of hosts can be configured as part of a cluster to support the virtual machines. For example, three hosts of a cluster may be used to provide the HA control plane with the control plane services, while additional hosts may provide computing resources to support deployed virtual machines. The HA control plane can use an active-standby configuration, a leader-follower configuration with quorums to implement a requested action, a leader-leader configuration with quorums that permit any of the leaders to implement the desired operation.

FIG. 7 illustrates a host computing system 700 to provide control plane services according to an implementation. Host computing system 700 is representative of any computing system or systems with which the various operational architectures, processes, scenarios, and sequences disclosed herein for a host computing system can be implemented. Host computing system 700 is an example of hosts 110-112, although other examples may exist. The example host computing system 700 includes an example storage system 745, an example processing system 750, and example communication interface 760. The example processing system 750 is operatively linked to the example communication interface 760 and the example storage system 745. The example communication interface 760 may be communicatively linked to the example storage system 745 in some implementations. The example storage system 745 includes example control plane manager 720, the example virtual machine deployment service 723, the example load balancer 724, the example control plane services 725. The example host computing system 700 may further include other components such as a battery and enclosure that are not shown for clarity.

The example communication interface 760 includes components that communicate over communication links, such as network cards, ports, radio frequency (RF), processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format—including combinations thereof. Communication interface 760 may be configured to communicate with one or more other host computing systems 700 that provide a cluster for an organization. The communications can include data communications between virtual endpoints, such as virtual machines, or may comprise control or configuration communications to support the configuration of the virtual endpoints. Communication interface 760 may further communicate with one or more client systems to receive requests in association with deploying virtual machines in the cluster. The communications can be received using a unique IP address for the host computing system or a virtual IP address that can be used to address multiple host computing systems in the cluster. In at least one example, a host computing system 700 may be assigned ownership of the virtual IP address, permitting the host with ownership to process the packets directed to the virtual IP address.

In some examples, the communication interface 760 is instantiated by programmable circuitry executing communication interface instructions and/or configured to perform operations such as those represented by the flowcharts of FIGS. 2,8.

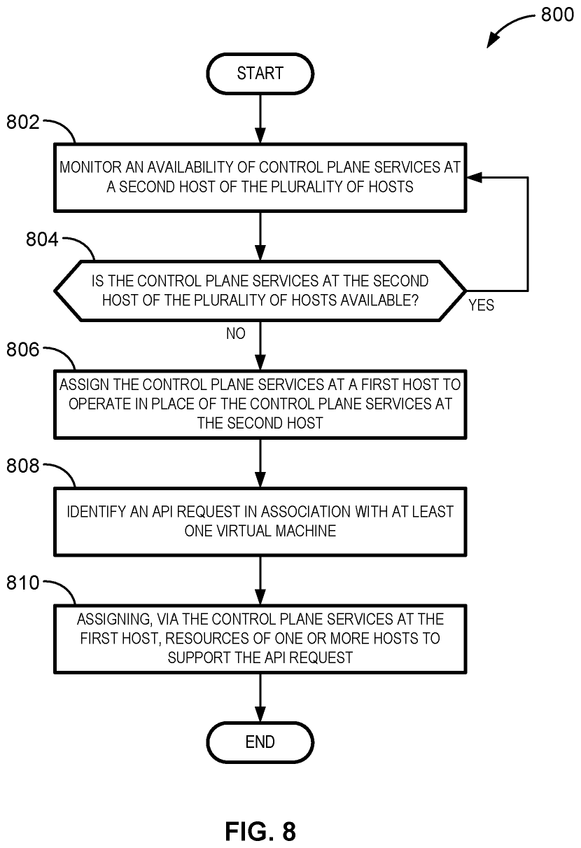

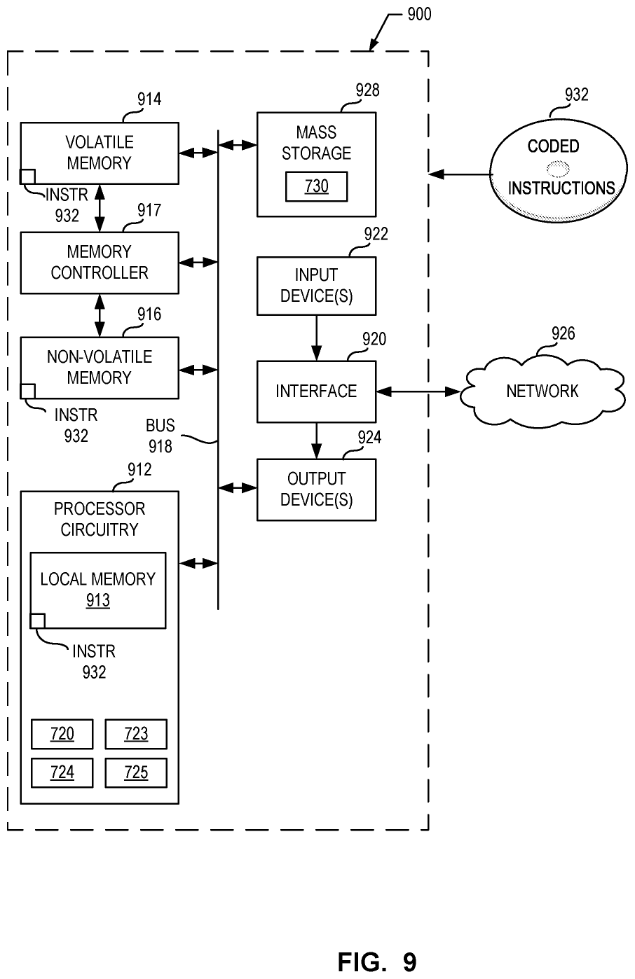

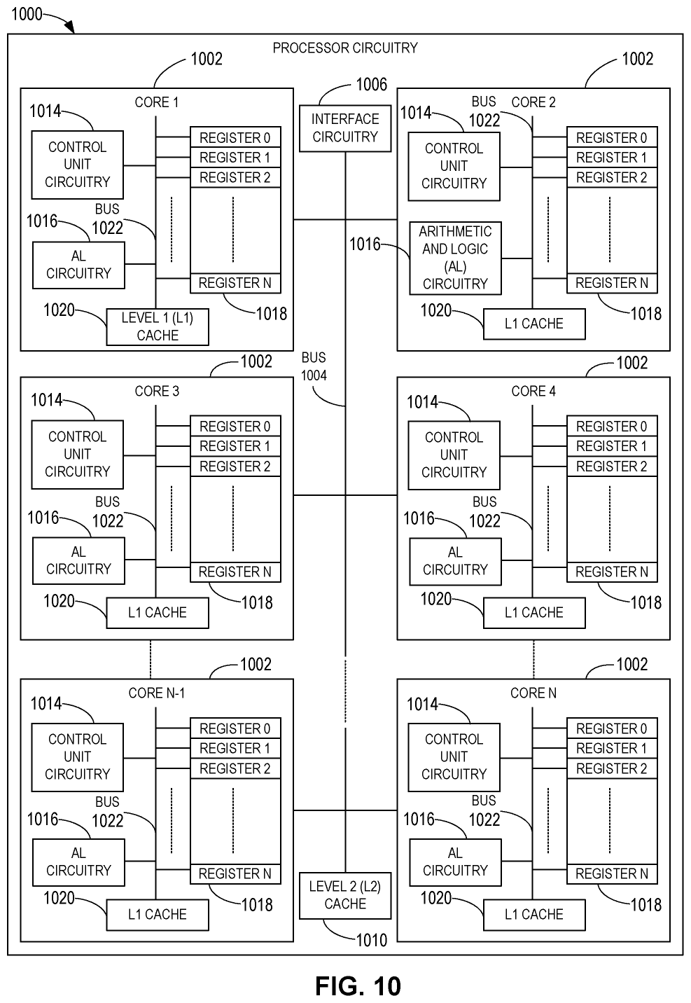

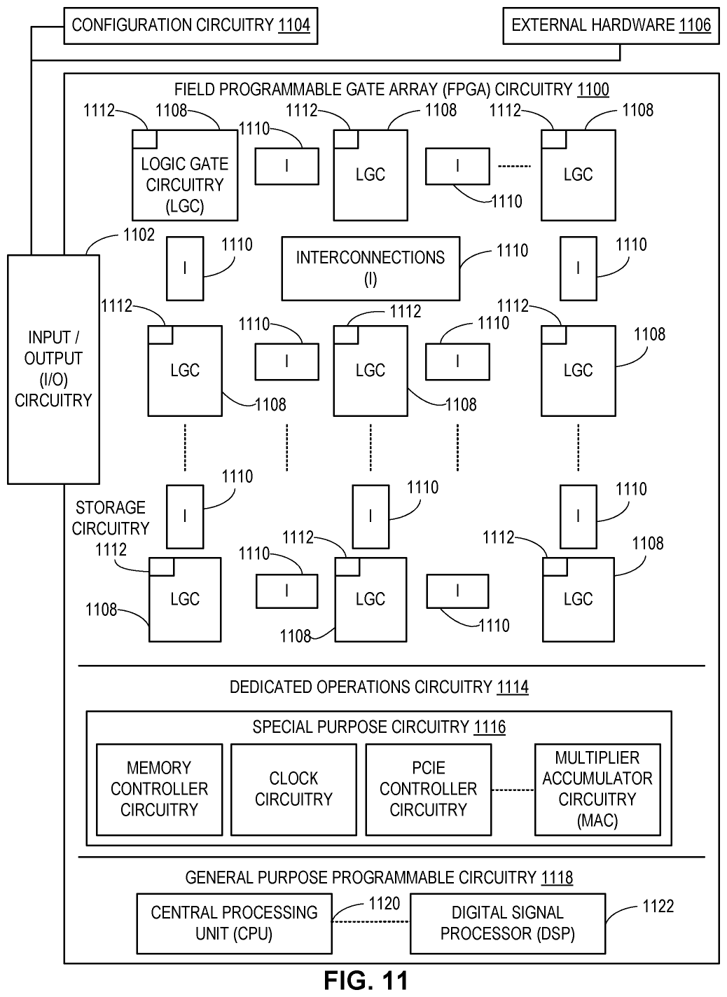

In some examples, the host computing system 700 includes means for identifying API requests. For example, the means for identifying API requests may be implemented by the communication interface 760. In some examples, the communication interface 760 may be instantiated by programmable circuitry such as the example programmable circuitry 912 of FIG. 9. For instance, the communication interface 760 may be instantiated by the example microprocessor 1000 of FIG. 10 executing machine executable instructions such as those implemented by at least blocks 201, 203 of FIG. 2 and block 808 of FIG. 8. In some examples, the communication interface 760 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the communication interface 760 may be instantiated by any other combination of hardware, software, and/or firmware. For example, the communication interface 760 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Processing system 750 includes an example microprocessor and other circuitry that retrieves and executes operating software from storage system 745. Storage system 745 may include volatile and nonvolatile, removable, and non-removable media implemented in any method or technology for storage of information, such as computer readable instructions, data structures, program modules, or other data. Storage system 745 may be implemented as a single storage device but may also be implemented across multiple storage devices or sub-systems. The storage system 745 may include additional elements, such as an example controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 750 is typically mounted on a circuit board that may also hold the storage system. The operating software of storage system 745 may include computer programs, firmware, or some other form of machine-readable program instructions. The operating software of storage system 745 includes example control plane manager 720, example control plane services 725, example virtual machine deployment service 723, and an example load balancer 724. The processing system 750 also includes an example data store 730. The operating software on storage system 745 may further include an operating system, utilities, drivers, network interfaces, applications, or some other type of software. When read and executed by processing system 750, the operating software on storage system 745 directs host computing system 700 to operate as a host described herein in FIGS. 1-6. In at least some examples, the example control plane services 725 directs the processing system 750 to provide and/or manage virtual machine allocations or assignments in a cluster.

In some examples, the processing system 750 is instantiated by programmable circuitry executing processor instructions and/or configured to perform operations such as those represented by the flowcharts of FIGS. 2, 8.

In some examples, the host computing system 700 includes means for managing virtual machine allocations in a cluster. For example, the means for managing may be implemented by the processing system 750. In some examples, the processing system 750 may be instantiated by programmable circuitry such as the example programmable circuitry 912 of FIG. 9. For instance, the processing system 750 may be instantiated by the example microprocessor 1000 of FIG. 10 executing machine executable instructions such as those implemented by at least blocks 802, 804, 808, 810 of FIG. 8. In some examples, the processing system 750 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the processing system 750 may be instantiated by any other combination of hardware, software, and/or firmware. For example, the processing system 750 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In at least some examples, the example control plane services 725 may monitor resource usage in the hosts of the cluster, identify resource requirements of the virtual machines, and select a host from the cluster to support the execution of the virtual machine. In some implementations, control plane services 725 may operate as part of a high availability cluster of control plane services that can be implemented in multiple different manners. In one example, control plane services 120 on a first host 110 of a cluster can provide active services, while control plane services 121, 121 on one or more other hosts may provide standby services. The standby services may remain idle or inactive until a failure of the primary services, wherein the idle or inactive services can be initiated to replace the failed services at a first host. In another example, control plane services, executed by the control plane services 120-122, may be configured as leader-leader or leader-follower. When a leader fails in a leader-follower configuration, a follower can be promoted to the leader, such that a quorum can be achieved and implemented via the leader.

In some examples, the control plane services 725 is instantiated by programmable circuitry executing processor instructions and/or configured to perform operations such as those represented by the flowcharts of FIGS. 2,8.

In some examples, the host computing system 700 includes means for monitoring resource usage in the hosts of the cluster, means for identifying resource requirements of virtual machines, and means for selecting a host from the cluster to support the execution of the virtual machine. For example, the means for monitoring resource usage in the hosts of the cluster, means for identifying resource requirements of virtual machines, and means for selecting a host from the cluster to support the execution of the virtual machine may be implemented by different ones of control plane services 725. In some examples, the control plane services 725 may be instantiated by programmable circuitry such as the example programmable circuitry 912 of FIG. 9. For instance, the control plane services 725 may be instantiated by the example microprocessor 1000 of FIG. 10 executing machine executable instructions such as those implemented by at least blocks 802, 804, 808, 810 of FIG. 8. In some examples, the control plane services 725 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the control plane services 725 may be instantiated by any other combination of hardware, software, and/or firmware. For example, the control plane services 725 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In addition to control plane services 725, host computing system 700 further includes control plane manager 720 that directs processing system 750 to manage control plane services 725 and the initiation of the control plane services. In some implementations, control plane manager 720 can be used to monitor the availability of control plane services at an active or leader host and can initiate the local control plane service when it is determined that the leader is unavailable. The initiation may include starting one or more containers to support the control plane services 725, wherein control plane manager 720 can manage the container images associated with control plane services 725.

In some examples, the control plane manager 720 is instantiated by programmable circuitry executing processor instructions and/or configured to perform operations such as those represented by the flowcharts of FIGS. 2,8.

In some examples, the host computing system 700 includes means for managing the control plane circuitry. For example, the means for managing the control plane circuitry may be implemented by control plane manager 720. In some examples, the control plane manager 720 may be instantiated by programmable circuitry such as the example programmable circuitry 912 of FIG. 9. For instance, the control plane manager 720 may be instantiated by the example microprocessor 1000 of FIG. 10 executing machine executable instructions such as those implemented by at least block 202 of FIG. 2 and block 802 of FIG. 8. In some examples, control plane manager 720 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the control plane manager 720 may be instantiated by any other combination of hardware, software, and/or firmware. For example, the control plane manager 720 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In at least one implementation, communication interface 760 receives a request to initiate a virtual machine, wherein the request is received at an endpoint IP address unique to host computing system 700 or a virtual IP address that can be assumed by multiple hosts in the cluster. In response to receiving the request, load balancer 724 selects an instance of control plane services that can support the request, wherein a single instance of the control plane services may execute on a single host (e.g., the first host 110) or multiple instances may execute across multiple hosts (e.g., the second host 111 and the third host 112). The instances may provide load balancer 724 with information about which of the instances is active or the instances that are leaders in some examples. As an example, a cluster may employ three instances of control plane services, wherein a first instance is the leader, and the two remaining instances are the followers. The leader instance can be advertised to load balancer 724 to indicate where requests should be forwarded, however, load balancer 724 may select any of the instances and the instances may in turn communicate the request to the appropriate leader. The selection of the instance may be random, may be based on resources available at the host for the instance, or may be based on some other factor.

After the request is forwarded to the control plane services instance, such as control plane services 725 that can execute on the same host with the load balancer 724, the control plane services can select a host to support the virtual machine. The selection can be based on the resource requirements for the virtual machine provided in association with the request, the available resources at each of the hosts in the cluster, or based on some other factor. Additionally, the control plane services may store configuration information associated with the virtual machine in a data store 730, wherein data store 730 can be representative of distributed storage system that can store the information across one or more hosts.

In some examples, the load balancer 724 is instantiated by programmable circuitry executing processor instructions and/or configured to perform operations such as those represented by the flowcharts of FIGS. 2, 8.

In some examples, the host computing system 700 includes means for balancing loads. For example, the means for balancing loads may be implemented by the load balancer 724. In some examples, the load balancer 724 may be instantiated by programmable circuitry such as the example programmable circuitry 912 of FIG. 9. For instance, the load balancer 724 may be instantiated by the example microprocessor 1000 of FIG. 10 executing machine executable instructions such as those implemented by at least blocks 806, 810 of FIG. 8. In some examples, load balancer 724 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the load balancer 724 may be instantiated by any other combination of hardware, software, and/or firmware. For example, the load balancer 724 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some implementations, data store 730 can be implemented as a high availability data store like the control plane services described herein. The high availability data store may be used to include duplicates of the configuration data for the cluster, wherein the configuration data can be used to recover the cluster after a failure.

When a selection is made by the control plane services of a host, the control plane services can contact a virtual machine deployment service, such as virtual machine deployment service 723 to initiate the virtual machine. The virtual machine deployment service may be on the same host as the control plane services or may be on a different host. As an example, control plane services 725 may determine a host to support a virtual machine in a cluster. In response to determining the host, control plane services 725 may provide a command or request to the host to initiate the virtual machine. The command or request can be communicated using a control plane network between the hosts.

In some examples, the virtual machine deployment service 723 is instantiated by programmable circuitry executing processor instructions and/or configured to perform operations such as those represented by the flowcharts of FIGS. 2, 8.

In some examples, the host computing system 700 includes means for deploying virtual machines. For example, the means for deploying virtual machines may be implemented by virtual machine deployment service 723. In some examples, the virtual machine deployment service 723 may be instantiated by programmable circuitry such as the example programmable circuitry 912 of FIG. 9. For instance, the virtual machine deployment service 723 may be instantiated by the example microprocessor 1000 of FIG. 10 executing machine executable instructions such as those implemented by at least block 810 of FIG. 8. In some examples, virtual machine deployment service 723 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the virtual machine deployment service 723 may be instantiated by any other combination of hardware, software, and/or firmware. For example, the virtual machine deployment service 723 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, when multiple instances of control plane services are active, the control plane services may be used to provide a quorum to verify the request for the virtual machine. The verification may include using public keys to identify a signature associated with the request from a client device. For example, in a leader-follower configuration may provide the virtual machine request to a leader instance, wherein the leader instance and the one or more followers may each process the signature to determine whether the request is valid (i.e., the source of the request). If a quorum is reached between the available instances of the control plane services, then the request can be processed, and a host selected to support the virtual machine.

In some implementations, failures can occur in association with an entire host, or a portion of the services provided by the host, wherein the services may include the control plane services, the data store, or some other service. When the failures occur, changes can be required to initiate or assign new services to replace the failed services. In at least one implementation, control plane manager 720 and/or control plane services 725 may monitor the availability of control plane services on another host, wherein the other host may provide the leader in quorum configuration or an active instance in an active-standby configuration. In monitoring the availability, heartbeat messages can be used to determine whether the control plane services are available, wherein the messages may be communicated using an overlay network associated with the high availability control plane. Once it is determined that the control plane services on the other host are unavailable, control plane services at another host in the high availability (HA) control plane 102 may assume the responsibilities of the unavailable control plane services. The assumption may include replacing the unavailable control plane services as a leader or replacing the unavailable control plane services as the active services.

In at least one implementation, the decision to act as the leader or the active services can be made by multiple control plane management services across different hosts. For example, when the control plane services 725 at a first host 110 in a three-host cluster fail, the control plane manager 720 may select a new leader from the remaining control plane services. The selection can be random, based on resources available at the hosts, or based on some other factor.

In some examples, rather than a failure of the control plane services themselves, a failure can occur in the networking of the cluster, such as network segmentation where one host may be unavailable due to communication failure. When the failure occurs, host computing system may provide various operations to maintain the ability of implementing virtual machine requests. In at least one implementation, a request to initiate a virtual machine can be received at communication interface 760. In response to the request, load balancer 724 directs processing system 750 to select control plane services to support the request, wherein the selected control plane services are in the minority (i.e., unable to develop quorum with one or more other control plane services). In this example, load balancer 724 can select control plane services 725 and control plane services 725 can initiate processes to implement the requested virtual machine. Here, any writes or configuration information associated with the virtual machine can be stored in a log, wherein the log can be used to identify virtual machine information that was initiated without developing a quorum. When control plane services 725 can communicate with other control plane services (i.e., networking is reestablished with the other control plane services), the control plane services can determine whether the virtual machine is approved. If approved, data associated with the virtual machine can be written to the data store, such that the other control plane services can use the data and the virtual machine can continue execution. If the virtual machine is not approved, such as when a quorum cannot be established for the new virtual machine, then the virtual machine can be stopped, and data associated with the virtual machine can be deleted from the log. Advantageously, this can permit a host to implement a new virtual machine optimistically and can terminate the virtual machine when the virtual machine is not permitted by the cluster of control plane services.

Although described in the previous examples as deploying a virtual machine, the API requests may include any requests in association with managing the cluster, including snapshots, power saving, removing a virtual machine, or some other API request. When a request is processed by the control plane services, the control plane services may assign resources of one or more hosts in the cluster to support the request. For example, when a request includes a request to terminate one or more virtual machines, the control plane services may identify one or more hosts for the virtual machines and assign services on the machines to terminate the execution of the corresponding virtual machines.

In some implementations, the control plane services operations described herein may occur only after a failure of a remote controller, wherein the remote controller can include one or more computers that support the management of one or more clusters. The failure can comprise hardware or software failure of the remote controller, networking failure in communications with the remote controller or some other failure. The failure can be identified locally by control plane manager 720 or can be identified via a notification from a remote client. In response to the failure, control plane services 725 can be initiated to support the API operations described herein without the use of the remote controller. Accordingly, while available, the remote controller can implement the desired API operations from the clients but can failover to the local control plane services in response to the failure. By implementing the control plane services locally, the cluster can be autonomous without requiring a connection to a remote controller.

The example host computing system 700 of FIG. 7 may be used to manage control plane services on a plurality of hosts (e.g., the hosts 110, 111, 112 of FIG. 1). The host computing system 700 may be instantiated (e.g., creating an instance of, bring into being for any length of time, materialize, implement, etc.) by programmable circuitry such as a Central Processor Unit (CPU) executing first instructions. Additionally or alternatively, the host computing system 700 of FIG. 7 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 7 may, thus, be instantiated at the same or different times. Some or all of the circuitry of FIG. 7 may be instantiated, for example, in one or more threads executing concurrently on hardware and/or in series on hardware. Moreover, in some examples, some or all of the circuitry of FIG. 7 may be implemented by microprocessor circuitry executing instructions and/or FPGA circuitry performing operations to implement one or more virtual machines and/or containers.

While an example manner of implementing the host computing system 700 is illustrated in FIG. 7, one or more of the elements, processes, and/or devices illustrated in FIG. 7 may be combined, divided, re-arranged, omitted, eliminated, and/or implemented in any other way. Further, the example control plane manager 720, the example virtual machine deployment service 723, the example load balancer 724, the example control plane services 725, the example processing system 750, the example communication interface 760, and/or, more generally, the example host computing system 700 of FIG. 7, may be implemented by hardware alone or by hardware in combination with software and/or firmware. Thus, for example, any of the example control plane manager 720, the example virtual machine deployment service 723, the example load balancer 724, the example control plane services 725, the example processing system 750, the example communication interface 760, and/or, more generally, the example host computing system 700, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example host computing system 700 of FIG. 7 may include one or more elements, processes, and/or devices in addition to, or instead of, those illustrated in FIG. 7, and/or may include more than one of any or all of the illustrated elements, processes and devices.

Flowcharts representative of example machine readable instructions, which may be executed by programmable circuitry to implement and/or instantiate the host computing system 700 of FIG. 7 and/or representative of example operations which may be performed by programmable circuitry to implement and/or instantiate the host computing system 700 of FIG. 7, are shown in FIGS. 2, 8. The machine readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 2, 8, many other methods of implementing the example host computing system 700 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2, 8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine readable instructions and/or example operations 800 that may be executed, instantiated, and/or performed by programmable circuitry to control hosts (e.g., the hosts 110-112 of FIG. 1). The example machine-readable instructions and/or the example operations 800 of FIG. 8 begin at block 802, at which the control plane manager 720 (FIG. 7) monitors an availability of control plane services 725 at a second host 111 of a plurality of hosts. For example, the control plane manager 720 may monitor an availability of the control plane services 725 at the second host 111 of a plurality of hosts by identifying and monitoring heartbeat messages transmitted from the second host 111 of the plurality of hosts. In some examples, control plane services 121 at the second host 111 self-monitors the availability of control plane services 121 at the second host 111.

At block 804, the control plane manager 720 determines if the control plane services 725 at the second host 111 of the plurality of hosts is available. For example, in response to the control plane manager 720 determining that the control plane services 725 at the second host 111 of the plurality are available (e.g., “YES”), control returns to block 802. Alternatively, in response to the control plane manager 720 determining that the control plane services 725 at the second host 111 of the plurality is not available (e.g., “NO”), control advances to block 806. In some examples, control plane services 121 at the second host 111 self-monitors the availability of control plane services 121 at the second host 111.

At block 806, the control plane manager 720 assigns the control plane services 725 at a first host 110 to operate in place of the control plane services 725 at the second host 111. For example, the control plane manager 720 may assign the control plane services 725 at the first host 110 (e.g., the control plane services 120) to operate in place of (e.g., act in place of) the control plane services 725 at the second host 111 (e.g., the control plane services 122). Control advances to block 808.

At block 808, the communication interface 760 identifies an API request in association with at least one virtual machine. For example, the communication interface 760 may identify the API request in association with the at least one virtual machine (e.g., the virtual machine 105 of FIG. 1, the virtual machine 605 of FIG. 6, the virtual machine 605 of FIG. 6, etc.) by receiving a unique IP address for a specific host computing system in the cluster of hosts. Control advances to block 810.

At block 810, the control plane services 725 at the first host 110 assigns resources of the one or more hosts to support the API request. For example, the control plane services 725 at the first host 110 (e.g., the control plane services 120) may assign resources of the one or more hosts (e.g., the first host 110 or the third host 112) to support the API request by deploying a virtual machine. For example, the control plane services 120 at the first host 110 may use virtual machine deployment service 723 to deploy the virtual machine (e.g., the virtual machine 605 of FIG. 6, the virtual machine 606 of FIG. 6). The example machine readable instructions and/or example operations 800 end.

FIG. 9 is a block diagram of an example programmable circuitry platform 900 structured to execute and/or instantiate the example machine-readable instructions and/or the example operations of FIGS. 2, 8 to implement the host computing system 700 of FIG. 7. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the example control plane manager 720, the example virtual machine deployment service 723, the example load balancer 724, the example control plane services 725, the example processing system 750, and the example communication interface 760.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 2, 8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 2, 8 to effectively instantiate the circuitry of FIG. 2 as logic circuits to perform operations corresponding to those machine readable instructions. In some such examples, the circuitry of FIG. 7 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 2, 8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMS s), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowchart(s) of FIGS. 2, 8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 2, 8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 2, 8. As such, the FPGA circuitry 1100 may be configured and/or structured to effectively instantiate some or all of the operations/functions corresponding to the machine readable instructions of the flowchart(s) of FIGS. 2, 8 as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 2, 8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 2, 8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. and the example FPGA circuitry 1100 of FIG. 11. In some such hybrid examples, one or more cores 1002 of FIG. 10 may execute a first portion of the machine readable instructions represented by the flowchart(s) of FIGS. 2, 8 to perform first operation(s)/function(s), the FPGA circuitry 1100 of FIG. 11 may be configured and/or structured to perform second operation(s)/function(s) corresponding to a second portion of the machine readable instructions represented by the flowcharts of FIG. 2, 8, and/or an ASIC may be configured and/or structured to perform third operation(s)/function(s) corresponding to a third portion of the machine readable instructions represented by the flowcharts of FIGS. 2, 8.

It should be understood that some or all of the circuitry of FIG. 7 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 7 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 7 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

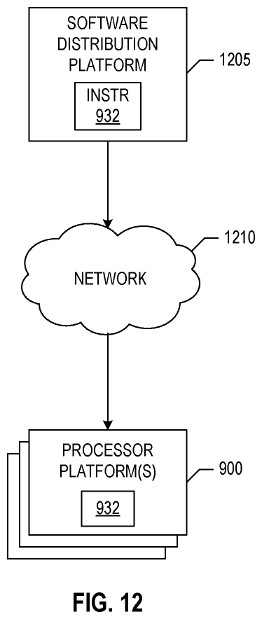

A block diagram illustrating an example software distribution platform 1205 to distribute software such as the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 2, 8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIG. 2, 8, may be downloaded to the example programmable circuitry platform 900, which is to execute the machine readable instructions 932 to implement the host computing system 700. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that manage a deployment of virtual machines in a cluster. Disclosed systems, apparatus, articles of manufacture, and methods improve the efficiency of using a computing device by allowing requests for virtual machines to be executed even if the host that the request for the virtual machine is unavailable or malfunctioned. This reduces wasted processor cycles from sending the same request for deployment of a virtual machine multiple times to a host that cannot receive the requests. Disclosed systems, apparatus, articles of manufacture, and methods are accordingly directed to one or more improvement(s) in the operation of a machine such as a computer or other electronic and/or mechanical device.

Example systems, apparatus, articles of manufacture, and methods have been disclosed that manage deployment of virtual machines in a cluster (e.g., autonomous clusters in a virtualization computing environment) are disclosed herein. Further examples and combinations thereof include the following: Example 1 includes a non-transitory machine readable storage medium comprising instructions to cause programmable circuitry to at least in a first host of a plurality of hosts, monitor, with first control plane services, an availability of second control plane services at a second host of the plurality of hosts, wherein the first control plane services and the second control plane services support implementation of application programming interface (API) requests in association with managing a cluster, the cluster including the plurality of hosts, after a determination that the second control plane services at the second host is not available, assign the first control plane services at the first host to operate in place of the second control plane services at the second host, in the first host, identify an API request in association with at least one virtual machine for the cluster, and in the first host, assign, via the first control plane services at the first host, resources of one or more hosts in the cluster to support the API request.

Example 2 includes the non-transitory machine readable storage medium of example 1, wherein the instructions are to cause the programmable circuitry to assign the first control plane services at the first host to operate in place of the second control plane services at the second host by initiating the first control plane services at the first host to act in place of the second control plane services at the second host.

Example 3 includes the non-transitory machine readable storage medium of example 1, wherein the instructions are to cause the programmable circuitry to assign the first control plane services at the first host to operate in place of the second control plane services at the second host by assigning the first control plane services to operate as a leader in place of the second control plane services at the second host.

Example 4 includes the non-transitory machine readable storage medium of example 1, wherein the instructions are to cause the programmable circuitry to after identification of the API request, determine whether a quorum exists for the API request via third control plane services on a third host of the plurality of hosts, wherein the assignment of resources of the one or more hosts occurs after a determination that the quorum exists to initiate the virtual machine.

Example 5 includes the non-transitory machine readable storage medium of example 1, wherein the instructions are to cause the programmable circuitry to store configuration information associated with the virtual machine in a data store.

Example 6 includes the non-transitory machine readable storage medium of example 1, wherein the first control plane services, on the first host, execute as one or more containers on the first host.

Example 7 includes the non-transitory machine readable storage medium of example 1, wherein the instructions are to cause the programmable circuitry to obtain the request from a third host of the plurality of hosts.

Example 8 includes the non-transitory machine readable storage medium of example 1, wherein the API request is to cause at least one of i) initiating at least one virtual machine in the cluster, ii) performing resource management in the cluster, or iii) performing storage management in the cluster.

Example 9 includes a system to operate a first host in a plurality of hosts of a cluster, the system comprising memory, programmable circuitry, and instructions to cause the programmable circuitry to monitor availability of a second instance of control plane services at a second host of the plurality of hosts, wherein ones of the instances of the control plane services support an implementation of application programming interface (API) requests in association with managing the cluster, in response to a determination that the second instance of the control plane services at the second host is not available, assign a first instance of the control plane services at the first host to operate in place of the second instance of the control plane services at the second host, identify an API request in association with at least one virtual machine for the cluster, and assign resources of one or more hosts in the cluster to support the API request.

Example 10 includes the system of example 9, wherein the programmable circuitry is to assign the first instance of the control plane services at the first host to operate in place of the second instance of the control plane services at the second host by initiating the first instance of the control plane services at the first host to operate in place of the second instance of the control plane services at the second host.

Example 11 includes the system of example 9, wherein the programmable circuitry is to operate the first instance of the control plane services at the first host to act in place of the second instance of the control plane services at the second host by assigning the first instance of the control plane services at the first host to operate as a leader in place of the second instance of the control plane services at the second host.

Example 12 includes the system of example 9, wherein the programmable circuitry is to in response to identifying the request to initiate the virtual machine, determine whether a quorum exists to initiate the virtual machine via a third instance of the control plane services on a third host of the plurality of hosts, and in response to determining that the quorum exists to initiate the virtual machine, assign the host of the plurality of hosts to support the virtual machine.

Example 13 includes the system of example 9, wherein the programmable circuitry is to store configuration information associated with the virtual machine in a data store.

Example 14 includes the system of example 9, wherein the first instance of the control plane services on the first host executes as one or more containers on the first host.

Example 15 includes the system of example 9, wherein identifying the request to initiate the virtual machine in the cluster includes obtaining the request from a third host of the plurality of hosts.

Example 16 includes the system of example 9, wherein the API request includes a request to at least one of i) initiate at least one virtual machine in the cluster, ii) perform resource management in the cluster, or iii) perform storage management in the cluster.

Example 17 includes a system comprising a plurality of hosts, a first host of the plurality of hosts configured to monitor availability of first control plane services at a second host of the plurality of hosts, wherein the first control plane services include at least one service to allocate a virtual machine to a host of the plurality of hosts, in response to determining that the first control plane services at the second host are not available, assign second control plane services at the first host to operate in place of the first control plane services at the second host, identify a request to initiate a virtual machine in the first host of the plurality of hosts, and assign, using the second control plane services at the first host, a host of the plurality of hosts to support the virtual machine.

Example 18 includes the system of example 17, wherein assigning the second control plane services at the first host to operate in place of the first control plane services at the second host includes initiating the second control plane services at the first host to operate in place of the first control plane services at the second host.

Example 19 includes the system of example 17, wherein assigning the second control plane services at the first host to operate in place of the first control plane services at the second host includes assigning the second control plane services to operate as a leader in place of the first control plane services at the second host.

Example 20 includes the system of example 17, wherein the first host is to after identification of the request to initiate the virtual machine, determine whether a quorum exists to initiate the virtual machine via third control plane services on a third host of the plurality of hosts, wherein assigning the host of the plurality of hosts to support the virtual machine occurs after a determination that a quorum exists to initiate the virtual machine.

Example 21 includes a method of operating a cluster including a plurality of hosts, the method comprising in a first host of the plurality of hosts, monitoring an availability of a second instance of control plane services at a second host of the plurality of hosts, wherein the control plane services supports implementation of application programming interface (API) requests in association with managing the cluster, in response to determining that the second instance of the control plane services at the second host is not available, assigning a first instance of the control plane services at the first host to act in place of the second instance of the control plane services at the second host, in the first host, identifying an API request in association with at least one virtual machine for the cluster, and in the first host, assigning, via the first instance of the control plane services at the first host, resources of one or more hosts in the cluster to support the API request.

Example 22 includes the method of example 21, wherein assigning the first instance of the control plane services at the first host to act in place of the second instance of the control plane services at the second host includes initiating the first instance of the control plane services at the first host to act in place of the second instance of the control plane services at the second host.

Example 23 includes the method of example 21, wherein assigning the first instance of the control plane services at the first host to act in place of the second instance of the control plane services at the second host includes assigning the first instance of the control plane services first to act as a leader in place of the second instance of the control plane services at the second host.

Example 24 includes the method of example 21, further including in response to identifying the API request, determining whether a quorum exists for the API request via a third instance of the control plane services on a third host of the plurality of hosts, wherein assigning resources of the one or more hosts occurs after a determination that the quorum exists to initiate the virtual machine.

Example 25 includes the method of example 21, further including storing configuration information associated with the virtual machine in a data store.

Example 26 includes the method of example 21, wherein the first instance of the control plane services on the first host executes as one or more containers on the first host.

Example 27 includes the method of example 21, wherein identifying the request to initiate the virtual machine in the cluster includes obtaining the request from a third host of the plurality of hosts.

Example 28 includes the method of example 21, wherein the API request is to at least one of i) initiate at least one virtual machine in the cluster, ii) perform resource management in the cluster, or iii) perform storage management in the cluster.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A non-transitory machine readable storage medium comprising instructions to cause programmable circuitry to at least:
in a first host of a plurality of hosts, monitor, with first control plane services, an availability of second control plane services at a second host of the plurality of hosts, wherein the first control plane services and the second control plane services support implementation of application programming interface (API) requests in association with managing a cluster, the cluster including the plurality of hosts;
after a determination that the second control plane services at the second host is not available, assign the first control plane services at the first host to operate in place of the second control plane services at the second host;
in the first host, identify an API request in association with at least one virtual machine for the cluster; and
in the first host, assign, via the first control plane services at the first host, resources of one or more hosts in the cluster to support the API request.

2. The non-transitory machine readable storage medium of claim 1, wherein the instructions are to cause the programmable circuitry to assign the first control plane services at the first host to operate in place of the second control plane services at the second host by initiating the first control plane services at the first host to act in place of the second control plane services at the second host.

3. The non-transitory machine readable storage medium of claim 1, wherein the instructions are to cause the programmable circuitry to assign the first control plane services at the first host to operate in place of the second control plane services at the second host by assigning the first control plane services to operate as a leader in place of the second control plane services at the second host.

4. The non-transitory machine readable storage medium of claim 1, wherein the instructions are to cause the programmable circuitry to:
after identification of the API request, determine whether a quorum exists for the API request via third control plane services on a third host of the plurality of hosts, wherein the assignment of resources of the one or more hosts occurs after a determination that the quorum exists to initiate the virtual machine.

5. The non-transitory machine readable storage medium of claim 1, wherein the instructions are to cause the programmable circuitry to store configuration information associated with the virtual machine in a data store.

6. The non-transitory machine readable storage medium of claim 1, wherein the first control plane services, on the first host, execute as one or more containers on the first host.

7. The non-transitory machine readable storage medium of claim 1, wherein the instructions are to cause the programmable circuitry to obtain the request from a third host of the plurality of hosts.

8. The non-transitory machine readable storage medium of claim 1, wherein the API request is to cause at least one of i) initiating at least one virtual machine in the cluster, ii) performing resource management in the cluster, or iii) performing storage management in the cluster.

9. A system to operate a first host in a plurality of hosts of a cluster, the system comprising:
memory;
programmable circuitry; and
instructions to cause the programmable circuitry to:
monitor availability of a second instance of control plane services at a second host of the plurality of hosts, wherein ones of the instances of the control plane services support an implementation of application programming interface (API) requests in association with managing the cluster;
in response to a determination that the second instance of the control plane services at the second host is not available, assign a first instance of the control plane services at the first host to operate in place of the second instance of the control plane services at the second host;
identify an API request in association with at least one virtual machine for the cluster; and
assign resources of one or more hosts in the cluster to support the API request.

10. The system of claim 9, wherein the programmable circuitry is to assign the first instance of the control plane services at the first host to operate in place of the second instance of the control plane services at the second host by initiating the first instance of the control plane services at the first host to operate in place of the second instance of the control plane services at the second host.

11. The system of claim 9, wherein the programmable circuitry is to operate the first instance of the control plane services at the first host to act in place of the second instance of the control plane services at the second host by assigning the first instance of the control plane services at the first host to operate as a leader in place of the second instance of the control plane services at the second host.

12. The system of claim 9, wherein the programmable circuitry is to:
in response to identifying the request to initiate the virtual machine, determine whether a quorum exists to initiate the virtual machine via a third instance of the control plane services on a third host of the plurality of hosts; and
in response to determining that the quorum exists to initiate the virtual machine, assign the host of the plurality of hosts to support the virtual machine.

13. The system of claim 9, wherein the programmable circuitry is to store configuration information associated with the virtual machine in a data store.

14. The system of claim 9, wherein the first instance of the control plane services on the first host executes as one or more containers on the first host.

15. The system of claim 9, wherein identifying the request to initiate the virtual machine in the cluster includes obtaining the request from a third host of the plurality of hosts.

16. The system of claim 9, wherein the API request includes a request to at least one of i) initiate at least one virtual machine in the cluster, ii) perform resource management in the cluster, or iii) perform storage management in the cluster.

17. A system comprising:
a plurality of hosts;
a first host of the plurality of hosts configured to:
monitor availability of first control plane services at a second host of the plurality of hosts, wherein the first control plane services include at least one service to allocate a virtual machine to a host of the plurality of hosts;
in response to determining that the first control plane services at the second host are not available, assign second control plane services at the first host to operate in place of the first control plane services at the second host;
identify a request to initiate a virtual machine in the first host of the plurality of hosts; and
assign, using the second control plane services at the first host, a host of the plurality of hosts to support the virtual machine.

18. The system of claim 17, wherein assigning the second control plane services at the first host to operate in place of the first control plane services at the second host includes initiating the second control plane services at the first host to operate in place of the first control plane services at the second host.

19. The system of claim 17, wherein assigning the second control plane services at the first host to operate in place of the first control plane services at the second host includes assigning the second control plane services to operate as a leader in place of the first control plane services at the second host.

20. The system of claim 17, wherein the first host is to:
after identification of the request to initiate the virtual machine, determine whether a quorum exists to initiate the virtual machine via third control plane services on a third host of the plurality of hosts, wherein assigning the host of the plurality of hosts to support the virtual machine occurs after a determination that a quorum exists to initiate the virtual machine.

21.-28. (canceled)
